(19) United States
(12) Patent Application Publication
(10) Pub. No.: US 2026/0127381 A1
(43) Pub. Date: May 7, 2026

(54) DEVICE AND METHOD FOR RESOLVING TEXTUAL AMBIGUITY THROUGH VISUAL LANGUAGE INFERENCE MODEL

(71) Applicant: UIF (University Industry Foundation), Yonsei University, Seoul (KR)

(72) Inventors: Youngjae YU, Seoul (KR); Jiwan CHUNG, Seoul (KR)

(73) Assignee: UIF (University Industry Foundation), Yonsei University, Seoul (KR)

(21) Appl. No.: 19/095,755

(22) Filed: Mar. 31, 2025

(30) Foreign Application Priority Data
Nov. 6, 2024 (KR) 10-2024-0156315

(51) Int. Cl. G06F 40/30; G06F 40/58

(52) U.S. Cl. CPC G06F 40/30; G06F 40/58

(57) ABSTRACT

The present disclosure relates to a device for resolving textual ambiguity through a visual language inference model, wherein the device includes: a pun identification unit that input an image and an original text, identifies a pun phrase in the original text utilizing the image as a clue, and generates a plurality of candidate translations; a pun semantic interpretation unit that input the plurality of candidate pun translations into the visual language inference model and decides a pun translation based on consistency with the image; and a pun reconstruction unit that reconstructs the pun translation by reflecting an intention of the original text.

### CROSS-REFERENCE TO RELATED PATENT APPLICATION

This application claims the benefit of Korean Patent Application No. 10-2024-0156315, filed on Nov. 6, 2024, in the Korean Intellectual Property Office, the disclosure of which is incorporated herein in its entirety by reference.

### TECHNICAL FIELD

The present disclosure relates to a textual ambiguity resolution technique through a visual language inference model, and more specifically, to a visual argumentation inference device and method that input a plurality of candidate pun translations into a visual language inference model, decides a pun translation based on the consistency with an image, and reconstructs the pun translation by reflecting an intention of the original text.

### BACKGROUND

In order for a natural language processing system to fully mimic human language comprehension ability, various types of ambiguity need to be resolved.

The following are the types of ambiguity:
1. Lexical ambiguity: When a word has multiple meanings
2. Syntactic ambiguity: When a word arrangement is interpreted in multiple grammatical structures
3. Scope ambiguity: When a sentence includes multiple quantifiers or scope expressions, and their relative order is ambiguous
4. Omission ambiguity: When the identity of an omitted word or phrase is ambiguous
5. Collective/distributive ambiguity: When plural expressions are interpreted collectively or distributively
6. Implication ambiguity: When the meaning implied by a sentence is ambiguous
7. Presupposition ambiguity: When the premise implied by a sentence is ambiguous
8. Idiomatic ambiguity: When a combination of words is interpreted either literally or as an idiom
9. Referential ambiguity: When the referent of a pronoun is ambiguous
10. General/non-general ambiguity: When it is ambiguous whether a sentence describes a general characteristic or a specific event
11. Type/entity ambiguity: When it is ambiguous whether a term refers to a type or an entity

In order for the natural language processing system to effectively resolve ambiguity, various technological innovations are needed. First, a model that may better understand and interpret the context is needed. To this end, methods such as improving self-attention mechanisms such as Transformer or improving the performance of language models such as BERT need to be considered. Second, mixed learning methods that combine supervised and unsupervised learning techniques need to be considered to enhance the ability to handle equivocality. In addition, methods for integrating external knowledge graphs or knowledge bases that help resolve ambiguity also need to be considered.

Korean Patent Application Publication No. 10-2022-7005746 (Sep. 3, 2020) relates to resolving natural language ambiguities with respect to a simulated reality setting. In an exemplary embodiment, a simulated reality setting having one or more virtual objects is displayed. A stream of gaze events is generated from the simulated reality setting and a stream of gaze data. A speech input is received within a time period and a domain is determined based on a text representation of the speech input. Based on the time period and a plurality of event times for the stream of gaze events, one or more gaze events are identified from the stream of gaze events. The identified one or more gaze events is used to determine a parameter value for an unresolved parameter of the domain. A set of tasks representing a user intent for the speech input is determined based on the parameter value and the set of tasks is performed.

### RELATED ART DOCUMENT

### Patent Document

Korean Patent Application Publication No. 10-2022-7005746, Sep. 3, 2020

### SUMMARY

An embodiment of the present disclosure provides a device and method for resolving textual ambiguity through a visual language inference model capable of receiving an image and an original text, identifying a pun phrase in the original text utilizing the image as a clue, and generating a plurality of candidate translations.

An embodiment of the present disclosure provides a device and method for resolving textual ambiguity through a visual language inference model capable of inputting a plurality of candidate pun translations into the visual language inference model and deciding a pun translation based on consistency with the image.

An embodiment of the present disclosure provides a device and method for resolving textual ambiguity through a visual language inference model capable of reconstructing a pun translation reflecting an intention of the original text.

According to embodiments, the device for resolving textual ambiguity through a visual language inference model includes: a pun identification unit that input an image and an original text, identifies a pun phrase in the original text utilizing the image as a clue, and generates a plurality of candidate translations; a pun semantic interpretation unit that input the plurality of candidate pun translations into the visual language inference model and decides a pun translation based on consistency with the image; and a pun reconstruction unit that reconstructs the pun translation by reflecting an intention of the original text.

The pun identification unit may detect an important phrase in the original text by understanding correlation between visual information in the image and the original text.

The pun identification unit may decide multimodal context for the important phrase to compute pun possibility, and decide the important phrase as the pun phrase when the pun possibility is higher than a specific standard.

The pun identification unit may interpret the pun phrase according to the multimodal context to generate the plurality of candidate translations.

The pun semantic interpretation unit may input each of the plurality of candidate pun translations into the visual language inference model to detect a visual clue in the image.

The pun semantic interpretation unit may decide whether the image is able to be interpreted as a pun interpretation image reflecting the corresponding candidate pun translation through the detected visual clue.

The pun semantic interpretation unit may adopt the corresponding candidate pun translation as the pun translation when the image is interpreted as the pun interpretation image reflecting the corresponding candidate pun translation.

The pun reconstruction unit may infer the intention of the original text based on visual information of the image and rearrange the pun translation centered on delivery of a core keyword in the pun translation.

The pun reconstruction unit may input the rearranged pun translation into the visual language inference model to re-decide the consistency with the image.

According to embodiments, a method for resolving textual ambiguity through a visual language inference model performed by a device for resolving the textual ambiguity includes: a pun identification stage that input an image and an original text, identifies a pun phrase in the original text utilizing the image as a clue, and generates a plurality of candidate translations; a pun semantic interpretation stage that input the plurality of candidate pun translations into the visual language inference model and decides a pun translation based on consistency with the image; and a pun reconstruction stage that reconstructs the pun translation by reflecting the intention of the original text.

### Advantageous Effects

The disclosed technology can have the following benefits. However, it does not mean that a specific exemplary embodiment should include the entire following benefits or should include only the following benefits, and it should not be understood that the scope of right of the disclosed technology is limited thereto.

A device and method for resolving textual ambiguity through a visual language inference model according to an embodiment of the present disclosure can receive an image and an original text, identify a pun phrase in the original text utilizing the image as a clue, and generate a plurality of candidate translations.

The device and method for resolving textual ambiguity through a visual language inference model according to an embodiment of the present disclosure can input a plurality of candidate pun translations into the visual language inference model and decide a pun translation based on consistency with the image.

The device and method for resolving textual ambiguity through a visual language inference model according to an embodiment of the present disclosure can reconstruct a pun translation reflecting the intention of the original text.

### BRIEF DESCRIPTION OF THE DRAWINGS

FIG. 1 is a diagram illustrating a device for resolving textual ambiguity through a visual language inference model according to an embodiment of the present disclosure.

FIG. 2 is a diagram illustrating a system configuration of the device for resolving textual ambiguity through the visual language inference model of FIG. 1.

FIG. 3 is a flowchart illustrating a method for resolving textual ambiguity through a visual language inference model according an embodiment of the present disclosure.

FIG. 4 is a comparison diagram of homogeneous pun (left) and heterogeneous pun (right) in the UNPIE dataset according to an embodiment of the present disclosure and a visual annotation diagram for resolution corresponding to each.

FIG. 5 is a diagram illustrating the diversity of topics appearing in visual premises and conclusions in human VisArgs according an embodiment of the present disclosure.

FIG. 6 is an exemplary diagram illustrating a process for generating a pun description image according to an embodiment of the present disclosure.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

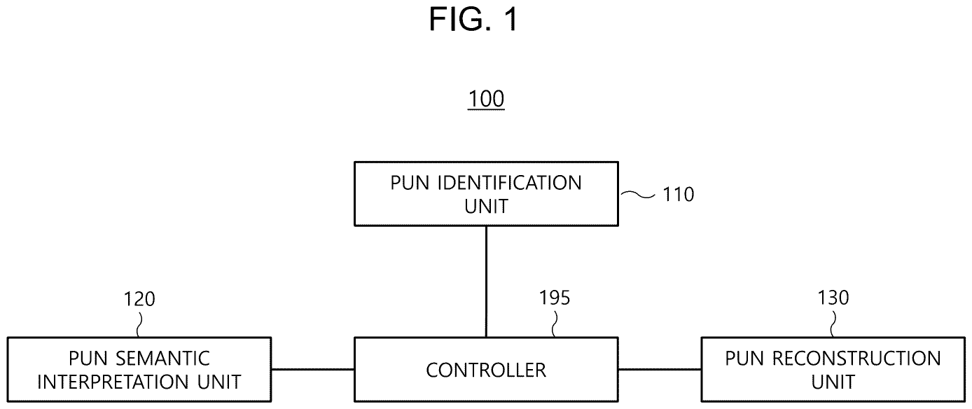

FIG. 1 is a diagram illustrating a device for resolving textual ambiguity through a visual language inference model according to an embodiment of the present disclosure.

Referring to FIG. 1, a device 100 for resolving textual ambiguity through a visual language inference model may include a pun identification unit 110, a pun semantic interpretation unit 120, and a pun reconstruction unit 130.

The pun identification unit 110 may input an image and an original text, identify a pun phrase in the original text utilizing the image as a clue, and generate a plurality of candidate translations.

More specifically, the operation of the pun identification unit 110 is as follows.

The pun identification unit 110 analyzes the input image to extract visual information related to the original text, and thus the context of the pun phrase in the original text may be understood. The pun identification unit 110 may apply an algorithm that extracts phrases with polysemous meanings of words and wordplay to identify the pun phrase, and may find phrases in which the pun is used contextually based on visual clues in the original text. The pun identification unit 110 may interpret the identified pun phrase in various ways to generate various candidate translations, and may consider various possibilities so that the dilogical meaning or nuance of the pun may be naturally expressed in other translations.

The pun identification unit 110 may detect an important phrase in the original text by understanding correlation between visual information in the image and the original text.

More specifically, the operation of the pun identification unit 110 is as follows.

The pun identification unit 110 may recognize components of an input image for visual information analysis and extract visual clues (for example, specific objects, backgrounds, or people) to understand relationships with text. The pun identification unit 110 may compare visual clues extracted from an image with the original text to evaluate correlation to the original text and evaluate whether a specific phrase or expression is closely associated with the image content. The pun identification unit 110 may identify original text phrases that are highly related to visual information as “important phrases” and select notable portions within the text based thereon.

The pun identification unit 110 may decide multimodal context for the important phrase to compute pun possibility, and decide the important phrase as the pun phrase when the pun possibility is higher than a specific standard.

More specifically, the operation of the pun identification unit 110 is as follows.

The pun identification unit 110 may understand the meaning or atmosphere that text and visual information combine to generate a multimodal (encompassing both images and text) context by integrating images and text for the important phrase. The pun identification unit 110 may calculate the possibility that the phrase includes pun (humor or wordplay) based on the multimodal context by using an algorithm that evaluates the ambiguity of words, reversed meanings between images and texts, or humorous elements to compute the pun possibility. The pun identification unit 110 may compare the computed pun possibility with a specific criterion, and determine that the phrase is a pun phrase when the subject value exceeds the criterion. The pun identification unit 110 may finally decide a phrase with a high pun possibility as a pun phrase, so that the humorous elements of the phrase may be considered in the subsequent translation or content generation process.

The pun identification unit 110 may interpret the pun phrase according to the multimodal context to generate the plurality of candidate translations.

More specifically, the operation of the pun identification unit 110 is as follows.

The pun identification unit 110 may attempt various interpretations of a pun phrase according to a multimodal context in which images and texts are combined. The pun identification unit 110 may understand the phrase by considering additional meanings or ambiguities provided by visual elements. The pun identification unit 110 may search for various interpretation possibilities by reflecting ambiguity, wordplay, or cultural elements of the pun phrase in order to apply various interpretation methods. For example, the pun identification unit 110 may consider interpretations that may produce different humorous benefits depending on the situation even for the same phrase. The pun identification unit 110 generates translations according to each interpretation method in order to generate candidate translations, and may allow the humor or nuance of the pun phrase to be expressed in various translation methods. In this process, the pun identification unit 110 may create translations that are similar but have slightly different meanings or expressions. The pun identification unit 110 may provide various candidate translations that are ultimately generated, thereby assisting in selecting a translation that best captures the intention and humor of the original text.

The pun semantic interpretation unit 120 may input the plurality of candidate pun translations into the visual language inference model and decide a pun translation based on consistency with the image.

More specifically, the operation of the pun semantic interpretation unit 120 is as follows.

The pun semantic interpretation unit 120 may input various candidate pun translations generated from the pun identification unit into a visual language inference model to evaluate how much each translation matches the image. The pun semantic interpretation unit 120 may analyze the correlation between the visual elements of the image and each translation through the visual language inference model to evaluate the consistency with the image, and compute the coincidence degree. In this connection, the pun semantic interpretation unit 120 may evaluate the consistency by considering the semantic connection between the image and the text and the appropriateness of the expression of humorous elements. In order to decide the pun translation based on consistency, the pun semantic interpretation unit 120 selects the translation that shows the highest consistency with the image among the candidate translations as the final pun translation, so that the translated text may be consistently intertwined with the visual elements of the image, and may clearly convey the humorous intention of the pun. The pun semantic interpretation unit 120 is finally ready to convey the selected pun translation along with an image, thereby providing a translation that most effectively reflects the humor and wordplay of the original text along with visual clues.

The pun semantic interpretation unit 120 may input each of the plurality of candidate pun translations into the visual language inference model to detect a visual clue in the image.

More specifically, the operation of the pun semantic interpretation unit 120 is as follows.

The pun semantic interpretation unit 120 may individually input each candidate pun translation into a visual language inference model to evaluate how each translation is connected to a specific visual clue in the image. The pun semantic interpretation unit 120 may search for visual elements (for example, specific objects, colors, or background images) that are likely to be connected to text in the image through the model to detect a visual clue, and may find the visual clue associated with the translation. For example, when the translation includes a mention of a specific object, the pun semantic interpretation unit 120 may check whether the object is detected in the image. The pun semantic interpretation unit 120 may analyze detailed elements to increase consistency between the visual clue and the translation by evaluating how much the detected visual clue matches the meaning of the translation to evaluate the connectivity between the translation and the visual clue, and thereby check whether the candidate translation is naturally connected to the image. The pun semantic interpretation unit 120 may be prepared to compute the coincidence degree with visual clues for all candidate translations, and select the phrase with the highest coincidence with the image among the translations.

The pun semantic interpretation unit 120 may decide whether the image is able to be interpreted as a pun interpretation image reflecting the corresponding candidate pun translation through the detected visual clue.

More specifically, the operation of the pun semantic interpretation unit 120 is as follows.

The pun semantic interpretation unit 120 may compare the detected visual clue with the candidate pun translation to evaluate whether the humorous elements included in the translation match the visual elements of the image. The pun semantic interpretation unit 120 may review whether the image may reflect a specific pun translation well during this comparison process. The pun semantic interpretation unit 120 may compute the possibility of interpreting the image as a “pun interpretation image” when the visual clues may sufficiently support the candidate translation for evaluating the possibility of the pun interpretation image. The pun semantic interpretation unit 120 may determine whether the humorous connectivity between the image and the translation is strong and whether the visual elements effectively convey the intention of the pun. The pun semantic interpretation unit 120 may decide that the image may be interpreted as a “pun interpretation image” reflecting the candidate translation when the computed possibility for deciding whether to interpret exceeds a certain standard. This decision is made based on the coincidence degree between the image and the translation, and may include an evaluation of whether humor or wordplay is naturally conveyed. The pun semantic interpretation unit 120 may finally be set to select the translation with the highest possibility of being interpreted as a “pun interpretation image,” thereby completing preparations to provide the optimal translation to a user.

The pun semantic interpretation unit 120 may adopt the corresponding candidate pun translation as the pun translation when the image is interpreted as a pun interpretation image reflecting the corresponding candidate pun translation.

More specifically, the operation of the pun semantic interpretation unit 120 is as follows.

The pun semantic interpretation unit 120 may evaluate whether the image may be interpreted as a pun interpretation image reflecting a specific candidate translation based on the coincidence degree between the detected visual clues and the candidate translation. The pun semantic interpretation unit 120 may adopt the corresponding translation as the final pun translation when the image sufficiently shows humorous connectivity with the candidate translation and the pun of the translation is naturally combined with the image in order to check whether the standard for selecting a pun translation is met. The pun semantic interpretation unit 120 may select a candidate translation that satisfies the evaluation standard as the final pun translation and finalize the same as a translation to be provided to a user thereafter. The pun semantic interpretation unit 120 may complete preparations for delivering the adopted final pun translation to the user together with the image and optimize the image and text to effectively deliver humor.

The pun reconstruction unit 130 may reconstruct the pun translation to reflect the intention of the original text.

More specifically, the operation of the pun reconstruction unit 130 is as follows.

The pun reconstruction unit 130 may analyze the humorous intention, nuance, or cultural context that the original text is intended to convey, and prepare such elements so as to be well reflected in the final translation. When the initial pun translation does not perfectly match the intention of the original text, the pun reconstruction unit 130 may reconstruct the translation to preserve the humor or ambiguity of the original text. In this process, the pun reconstruction unit 130 may adjust the sentence structure or word selection so that the translation may be expressed more clearly and naturally. When the pun of the original text depends on a specific cultural background or linguistic characteristic, the pun reconstruction unit 130 may adjust the same so as to be understood also in other languages and cultures and reflect the same in the translation, so that a reader may convey humor or meaning similar to the original text when reading the translated text. The pun reconstruction unit 130 may conduct a final review to check whether the reconstructed translation well reflects the intention of the original text, and may revise the same when needed to ensure that the translation is conveyed naturally and effectively. The final pun translation, for which the reconstruction work has been completed by the pun reconstruction unit 130, may now be finally finalized and prepared for delivery to a user.

The pun reconstruction unit 130 may infer the intention of the original text based on the visual information of the image and rearrange the pun translation centered on the delivery of a core keyword in the pun translation.

More specifically, the operation of the pun reconstruction unit 130 is as follows.

The pun reconstruction unit 130 may analyze the visual elements of the image to more clearly understand the intention to be conveyed in the original text. The pun reconstruction unit 130 may understand how the original text intends to express a specific humor or message, and may utilize the same as an important clue in the translation process. The pun reconstruction unit 130 may identify major keywords that are core elements of the pun to be conveyed in the original text and image. These keywords have important meanings in the translation and may play a central role in the humor. The pun reconstruction unit 130 may rearrange the translation so that the identified core keywords are conveyed most effectively. For example, the pun reconstruction unit 130 may adjust the word order or sentence structure by consideration when the pun of the original text is connected to a specific visual element of the image, so that a reader may understand the meaning of the pun more intuitively. The pun reconstruction unit 130 maintains semantic consistency between the original text and the translation even during the process of rearranging the translation, and adjusts the same so that the intention and humorous benefit of the pun are not damaged, thereby allowing the translation to blend naturally with the image and increase its delivery power. The pun reconstruction unit 130 may finally review the rearranged translation to ensure that the core keywords are effectively delivered while the humor of the original text is not distorted.

The pun reconstruction unit 130 may input the rearranged pun translation into the visual language inference model to re-decide the consistency with the image.

More specifically, the operation of the pun reconstruction unit 130 is as follows.

The pun reconstruction unit 130 may input the reconstructed pun translation into the visual language inference model, and re-evaluates the coincidence degree between the image and the translation, thereby checking whether the consistency between the visual clue and the translation is maintained even after the translation is rearranged. The pun reconstruction unit 130 may compare the visual information of the image with the rearranged translation through the model, and evaluate whether the humorous elements and meaning are naturally connected with the image. The pun reconstruction unit 130 may re-analyze how the visual clue is connected with the core keyword of the translation, and check whether the humor is effectively conveyed. When the reconstructed translation shows a high coincidence degree with the image, the pun reconstruction unit 130 may decide that the translation is suitable as the final pun translation. When the coincidence degree is insufficient, the configuration of the translation may be readjusted or additional modifications may be determined as being necessary. The pun reconstruction unit 130 may complete preparations for adopting the translation whose coincidence has been sufficiently checked as the final pun translation, thereby preparing to provide a user with a form in which the image and text are organically combined. The pun reconstruction unit 130 may finally output the translation after checking that the image and the translation are harmoniously connected through a final review.

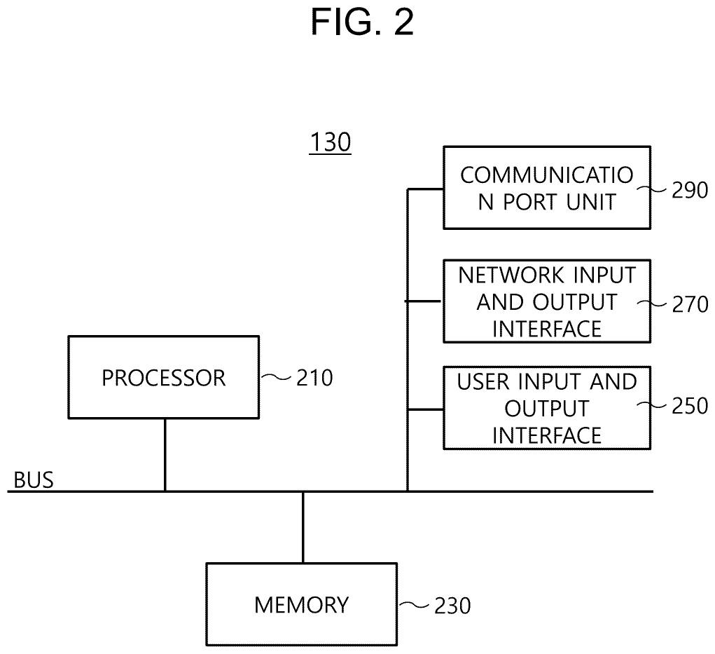

FIG. 2 is a diagram illustrating a system configuration of the device for resolving textual ambiguity through the visual language inference model of FIG. 1.

Referring to FIG. 2, the device 100 for resolving the textual ambiguity through the visual language inference model may include a processor 210, a memory 230, a user input and output interface 250, a network input and output interface 270, and a communication port unit 290.

The processor 210 may receive a question consisting of an image and text through a text-only language model and a vision-language model, generate a text response and a multimodal response to the question, manage the memory 230 that is read or written in the process, and schedule a synchronization time between a volatile memory and a non-volatile memory in the memory 230. The processor 210 may control the overall operations of the device 100 for resolving the textual ambiguity through the visual language inference model, and is electrically connected to the memory 230, the user input and output interface 250, the network input and output interface 270, and the communication port unit 290 to control the data flow therebetween. The processor 210 may be implemented in the form of a central processing unit (CPU) or a graphics processing unit (GPU) of the device 100 for resolving the textual ambiguity through the visual language inference model.

The memory 220 may be implemented in the form of a non-volatile memory such as a solid state disk (SSD) or a hard disk drive (HDD). The memory 220 may include an auxiliary memory used to store overall data necessary for the device 100 for resolving the textual ambiguity through the visual language inference model and may include a main memory implemented in the form of a volatile memory, such as a random access memory (RAM). In addition, the memory 230 may store a set of instructions that execute the role of the device 100 for resolving the textual ambiguity through the visual language inference model according to an embodiment of the present disclosure by being executed by the electrically connected processor 210.

The user input and output interface 250 may include an environment for receiving a user input or an environment for outputting specific information to a user. For example, the user input and output interface 250 may include an input device including an adapter, such as a touch pad, a touch screen, an on-screen keyboard, and a pointing device, and may include an output device including an adapter, such as a monitor and a touch screen. In an embodiment, the user input and output interface 250 may correspond to a computing device being accessed through a remote access, and, in this connection, the device 100 for resolving the textual ambiguity through the visual language inference model may serve as an independent server.

The network input and output interface 270 may provide a communication environment for connecting to an attack IP terminal or a test IP terminal through a network and include an adaptor for communication through, for example, a local area network (LAN), a metropolitan area network (MAN), a wide area network (WAN), and a value added network (VAN). In addition, the network input and output interface 270 may be implemented to provide a short-range communication function through Wi-Fi or Bluetooth networks or a wireless communication function involving 4G or higher communication specifications for wireless transmission of data.

The communication port unit 290 is a hardware interface for connecting to external hardware. For example, the external hardware may include a printer, a mouse, and USB hardware. The communication port unit 290 may sense the connection of specific USB hardware and perform the role of a CTI augmented device 130.

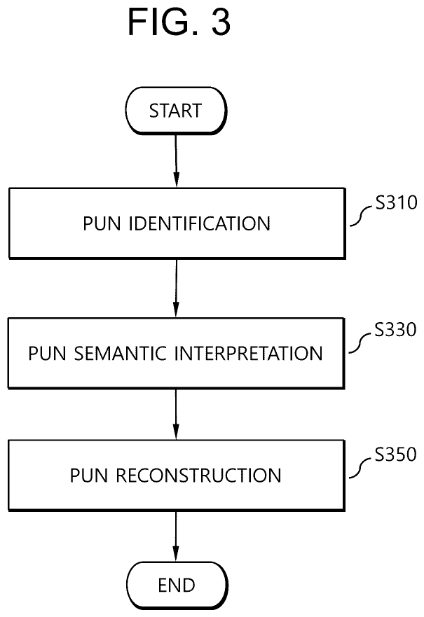

FIG. 3 is a flowchart illustrating a method for resolving textual ambiguity through a visual language inference model according an embodiment of the present disclosure.

In FIG. 3, the device 100 for resolving the textual ambiguity through the visual language inference model performs: a pun identification stage that input an image and an original text, identifies a pun phrase in the original text utilizing the image as a clue, and generates a plurality of candidate translations (stage S310); a pun semantic interpretation stage that input the plurality of candidate pun translations into a visual language inference model and decides a pun translation based on consistency with the image (stage S330); and a pun reconstruction stage that reconstructs the pun translation by reflecting the intention of the original text (stage S350).

In stage S310, the pun identification unit 110 may find the pun phrase in the original text based on the input image and the original text utilizing the image as a clue, and generate several candidate translations based thereon.

In stage S330, the pun semantic interpretation unit 120 may input the plurality of candidate pun translations into a visual language inference model, evaluate the coincidence with the image, and finally decide on the most suitable pun translation.

In stage S350, the pun reconstruction unit 130 may refine the translation while preserving the humor and ambiguity of the pun through a process of reconstructing the pun translation more naturally and effectively by reflecting the intention of the original text, so as to create a translation that optimally expresses the intention of the original text and the image.

### 1. Overview of UNPIE Benchmark

UNPIE is a new multimodal multilingual benchmark. Its primary aim is to assess machines' capacity to actively integrate visual information to resolve ambiguity in text. The dataset leverages puns that inherently contain such ambiguity to study the challenge of multimodal literacy in a natural environment.

UNPIE extends puns in two directions: visual context and multilingual translations. First, two types of images are collected for each pun that 1) describes both meanings of the pun to explain it and 2) depicts only one meaning of the pun to disambiguate the pun. While one may naturally retrieve images for disambiguation from the web, images that illustrate the ambiguity of the pun in a single canvas are rare. Thus, a text-to-image model (Betker et al., 2023) was used to generate such images. Human annotators are then employed to review the images so as to correctly explain the given pun.

In addition, human annotators are asked to translate the English pun sentences into multilingual targets. Importantly, the ambiguity does not need to carry on to the translation target.

1.1. Collecting Puns with Visual Context

### Base Text-Only Pun Data

A multimodal multilingual benchmark is built based on the text only English pun dataset of SemEval 2017 Task 7 (Miller et al., 2017). The dataset bounds the pun understanding problem in two ways to rely less on external requirements: first, each sentence contains a maximum of one pun. Hence, a sentence's lexical ambiguity is regulated, at least in terms of puns. Second, most pun has a lexical entry in WordNet 3.1 (81% of the whole data). This vocabulary limit keeps the dataset from being dominated by many out-of-vocabulary words.

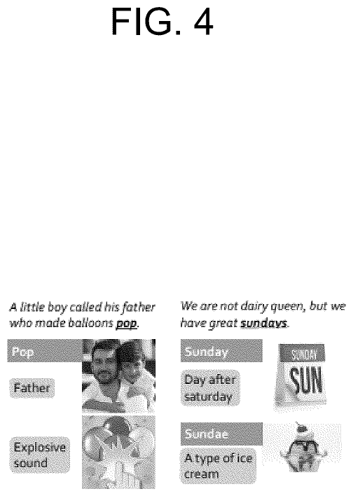

The data is divided into homographic and heterographic puns, depending on the surface form of the puns. As shown in FIG. 4, homographic puns have identical spelling and pronunciation but different meanings, while heterographic puns differ in spelling and meanings. This categorization scheme is inherited and experiment results for homographic and heterographic puns are reported separately.

From the SemEval 2017 collection of 2,878 English pun sentences, 500 homographic and 500 heterographic puns with concrete concepts that are more specifically visualized through images were selected.

### Generating Pun Explanation Images

UNPIE is designed to assess a capability of vision-language model (VLM) to resolve lexical ambiguity with visual context. In terms of a pun, the context needs to depict both meanings within the pun. However, such images are hard to find among natural images due to their complex and sometimes ambivalent meanings. Further, such visual designs are typically proprietary, which contradicts the goal of UNPIE of an open-source dataset. Hence, new images that fit the requirements are resorted to be created.

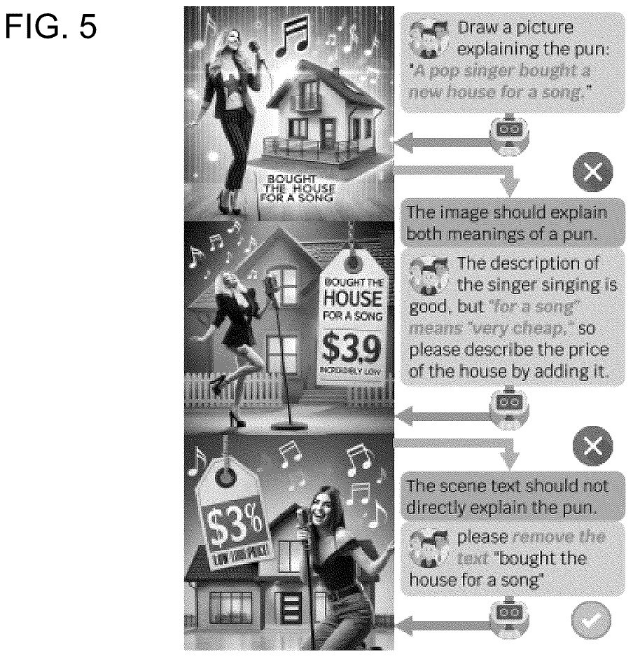

Three NLP researchers were recruited to prompt the text-to-image generation model DALLE 3 (Betker et al., 2023) to create images fitting the pun criteria while maintaining a natural appearance. The base text-only dataset provided the puns as data seeds (Miller et al., 2017). While relative freedom was allowed in the choice of prompts, the researchers reported that DALL-E 3 typically produced satisfactory images with straightforward instructions (see FIG. 5). Thanks to DALL-E 3's multi-turn interface, the researchers could request further image revisions when the initial output was unsuitable. On average, about 24% samples needed such multi-step modification. Finally, 1000 pun explanation images were obtained after this process.

### Retrieving Pun Disambiguator Images

UNPIE offers an alternative visual context, providing two images that describe each meaning of each pun. These images disambiguate the pun and are intended to be used in the binary classification task of pun disambiguation. As a pun disambiguator image is aligned to a single meaning, searching for the image is easier compared to the pun explanation images that require encoding both meanings in the same image. Hence, image retrieval is opted from the LAION 2B web image-text dataset (Schuhmann et al., 2022) rather than image generation.

Using the CLIP (Radford et al., 2021)-based image search API (Beaumont, 2022), ten images per the meaning of each pun are retrieved. Then, the image that best fits the description is manually selected. The whole sample is discarded when there is no suitable image. Two criteria were considered when selecting the images: first, images that explicitly contain the meaning or the pun word itself as printed text are discouraged as such images reward OCR capability rather than general visual understanding. Second, images with watermarks are filtered out to avoid confusion.

### 1.2. Translating Puns to Multilingual Targets

Evaluating a machine's ability to understand puns is a complex task. Without a rule-based algorithm to measure this capability, the assessment often relies on human judgment or other machines. However, relying on human evaluation may limit the scalability of the assessment process, while machine based evaluation, such as using models like GPT4 (OpenAI, 2023), may introduce undesirable biases (Liu et al., 2023c; Hada et al., 2023). To overcome these challenges, an alternative evaluation method is suggested via a downstream task in translation, aligning with previous research in the field of multimodal machine translation.

This approach provides a new evaluation mode to measure the ability of machines to resolve linguistic ambiguity by leveraging multimodal information as a method to evaluate how effectively machines may understand and translate a pun in multilingual translation tasks.

The English pun sentence is translated into German, French, and Korean. In this connection, it needs to be ensured that the ambiguity in English does not carry over into the translated languages. To this end, a cooperative translation framework between machines and humans is designed.

Per each language pair (for example, English→German), a bilingual user whose native language is the target language (for example, German) was recruited. First, off-the-shelf translation models were used to generate three translation candidates. Then, the human translators select the optimal candidate and make further modifications to finalize the translation. This machine-assisted translation mode aligns with common practices in the industry (Federico et al., 2012).

There are two reasons for choosing this method: firstly, it was identified that the human translators find pun translation difficult. Machine translation suggestions may serve as starting points. Secondly, this method expedited the annotation process and reduced costs.

Cases arise where the ambiguity in the source language is retained in the translated text in literal translation. For example, consider the sentence: “A baseball player was a thief. He was always trying to steal.” The pun in this sentence relies on the dual meanings of “steal”—“to take without permission” and “to steal a base in baseball.” The challenge in translation is twofold: Some languages contain equivalent idiomatic expressions (e.g., “stehlen” in German), which may result in similar ambiguities in the translation.

To address this issue, translators were instructed to select alternative words that avoid unintended double meanings whenever possible. Since the humor of the pun is implied contextually within the first sentence, the meaning may be conveyed even when the pun word itself is not explicitly mentioned. For such instances, indirect translations were permitted, allowing translators to render interpretations of the meanings of the pun in various ways.

In addition, to further refine the outputs, text-based deduplication was applied to eliminate similar translations.

### 1.3. Dataset Analysis

The pipeline yields a dataset comprising 500 homographic and 500 heterographic pun sentences, each accompanied by one pun explanation image, two pun disambiguator images, and translations to three languages.

### Evaluation of Naturalness of Generated Images

Given the limited availability of real-world images accurately depicting actual puns, AI-generated images were used. To gauge the difference between generated and authentic images, two human evaluation studies were conducted, comparing the generated images against natural image-pun pairs sourced from the web.

In the first study, human evaluators were asked to identify the correct text pun associated with each image from a set of potential matches. Results showed that natural images achieved an accuracy of 86%, while the generated images achieved a slightly higher accuracy of 92%. This test was conducted using a set of 50 randomly selected images.

In the second study, an A/B comparison was conducted to assess the naturalness of generated images and natural images. To ensure consistency, natural images containing multiple panels, written text, or well-known characters were excluded from the evaluation. Across three independent evaluators, the naturalness test resulted in accuracy rates of 66%, 72%, and 74%, respectively, using another set of 50 random images.

Overall, despite slight distributional differences between the generated and natural pun images, the disparity is considered acceptable. These findings indicate that evaluations performed within the benchmark may be reasonably extrapolated to real-world settings.

Common vs. Uncommon Meanings

In UNPIE, each sample contains a pun phrase with two different meanings. This section explores how the popularity, or frequency of each meaning influences downstream performance. To investigate, the meanings of each word were ranked by frequency using GPT-4 to perform zero-shot assessments. To ensure the accuracy of GPT-4's assessments, cross-reference was performed with reference to human-annotated data based on frequency data of 890 homonyms provided by Rice et al. (2019). The lower section of Table 2 compares GPT-4's frequency rankings with actual frequency rankings of the human-annotated data.

TABLE 2
Experiment on the effect of meaning frequency in puns. Top:
division of pun reconstruction task results according to the
commonality of meanings. Bottem: assessment of GPT-4-based
meaning frequency ordering against an independent dataset with
human-annotated meaning frequencies (Rice et al., 2019).

| | |
|---|---|
| En→Fr | En→De |
| Meaning | Meaning |

| Model | Freq↑ | Freq↓ | Freq↑ | Freq↓ |
|---|---|---|---|---|
| GPT4 | 68.5 | 75.9 | 71.2 | 73.4 |
| +Caption | 73.4 | 77.8 | 74.6 | 76.6 |

| | Accuracy (%) | Cohen Kappa (κ) |
|---|---|---|
| GPT4Eval | 78.1 | 0.39 |

Next, using GPT-4, the data was categorized into two groups based on more and less frequent meanings. As illustrated in the upper part of Table 2, the pun reconstruction task reveals that input with high frequency meanings present more challenges than those with uncommon meanings. This suggests that texts with an uncommon meaning supplement the model's general frequency-based understanding, enabling more complex semantic interpretations.

### Difference Between Disambiguated Translations and Unconditional Ones

When disambiguation is enforced as a strict criterion, the resulting translations are expected to differ from straightforward, unconditional translations. To quantify the extent of this difference, the unconditional translation [symbol] was compared against two baselines: (1) another unconditional translation [symbol] produced by a different annotator, and (2) the disambiguated translation y. Text similarity scores were measured for each translation pair to calculate: s₁=sim( [symbol] , [symbol] ) and s₂=sim( [symbol] ,y). In addition, the win rate was computed as the proportion of cases where s₂ exceeds s₁.

The results, summarized in Table 3, show that although disambiguation instructions lead to noticeable changes, the overall difference remains relatively small.

TABLE 3
Statistical differences between unconditional translation and
pun-aware translation, averaged across languages. Text similarity
was evaluated using BERTScore (Zhang et al., 2019).

| Metric | Translation | Homo | Hetero |
|---|---|---|---|
| Win Rate (%) | Plain | 90.7 | 82.1 |
| | Pun-aware | 9.3 | 17.9 |
| Score (Average) | Plain | 94 | 93.9 |
| | Pun-aware | 88.8 | 87.8 |

### 2. Task Overview

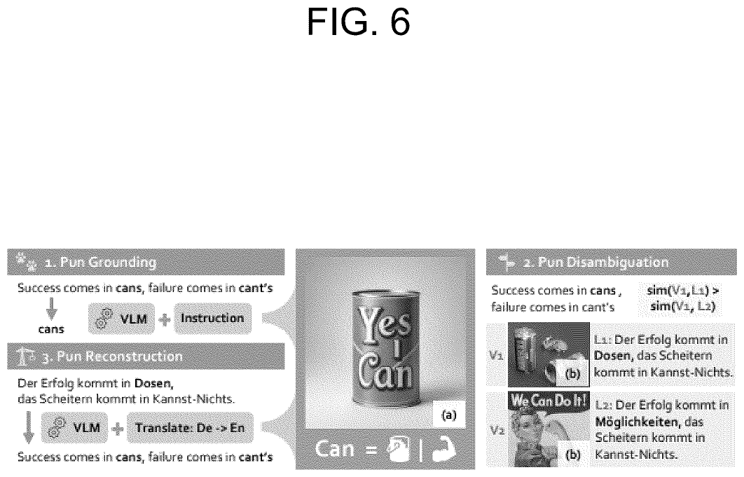

Three multimodal pun understanding tasks were posed on the collected annotated data to test models' capability to use visual context in addressing lexical ambiguity. Each task evaluates different aspects, and an outline of these tasks is shown in FIG. 6.

### Pun Grounding

The first task is an easy one that may be solved without image input, and is aimed at determining if less advanced models may enhance their performance with added visual information.

### Pun Disambiguation

The second task is designed to necessitate the usage of visual context. This task evaluates the model's capability to resolve ambiguities that require image information.

### Pun Reconstruction

The final task replicates a practical multimodal literacy scenario. This task necessitates that models not only use the given translation but also infer or extract the pun meaning that the translation does not explicitly convey, potentially drawing on visual inputs to do so.

These tasks allow comprehensive testing of the model's capability to utilize multimodal information.

### Pun Grounding

The first stage in understanding a pun is to identify the pun. The initial task examines whether visual context aids models in identifying pun phrases within sentences. Given the English sentence

$${x}^{i} = [ {x}_{0}^{i} , … , {x}_{t}^{i} ]$$

containing a pun phrase

$${s}^{i} = [ {x}_{k}^{i} , … , {x}_{l}^{i} ]$$

and its corresponding pun explanation image

$${v}_{e}^{i} ,$$

the model returns a pun phrase candidate s̅ⁱ.

While the actual target phrase sⁱ is part of the full sentence xⁱ, the model's output s̅ⁱ is not bound by this constraint. This task was formulated as a sequence-to-sequence problem to facilitate zero-shot evaluation across various baselines. The model's output is then assessed for exact text match with the actual pun phrase to decide accuracy.

### Pun Disambiguation

Once models pinpoint a pun's location, its semantics then need to be interpreted. Understanding a pun hinges on recognizing the different meanings of the pun phrase, as its humor lies in this ambiguity. In this task, the models' proficiency in correlating each meaning of the pun with its associated visual context is assessed.

Given the English sentence xⁱ and the pun disambiguator image

$${v}_{d}^{i}$$

aligned with one of the meanings constructing the pun, the model needs to produce a translation of the sentence into a target language (for example, German

$${\overline{y}}_{i , j}^{De} ) .$$

The translated text needs to be free of any ambiguity stemming from the pun, aligning with the meaning depicted in the provided image.

The model-generated translation

$${\overline{y}}_{i , j}^{De}$$

is compared with two translation targets

$${y}_{i . 0}^{De} ,$$

$${y}_{i \text{.1}}^{De} ,$$

each corresponding to two different meatnings of the pun. The model's output is considered correct when it resembles the ground-truth translation

$${y}_{i . j}^{De}$$

that corresponds to the image

$${v}_{i , j}^{d} .$$

### Pun Reconstruction

The final task is to reconstruct the complete pun sentence. To make the problem deterministic, two types of inputs are provided to the model: a non-English language translation of the original pun sentence that has been clarified of any ambiguities (for example, German

$${y}_{i . j}^{De} )$$

and the related pun explanation image

$${v}_{i}^{e} .$$

The model then generates an output x̅ⁱ based thereon, which was compared with the original English pun sentence xⁱ to evaluate whether both English sentences encapsulate the same pun.

It is a complex task to decide whether two sentences contain the same pun, and machine-based evaluation is performed utilizing GPT-4 to obtain the binary decision.

### 3. Experiments on UNPIE Benchmark

### 3.1. Models

### Language Model (LM)

To measure the effectiveness of multimodal modeling, baseline models are established using unimodal text-only language models. Herein, an open-source model (Vicuna-13B (Chiang et al., 2023)) and the advanced proprietary language model (GPT-4 (OpenAI, 2023)) are incorporated. Furthermore, in order to test a visual-language model, LLaVA, for a text-only scenario, only text prompts are input without the images. This approach assesses the concept of multimodal alignment tax (Chen et al., 2023) in the context of pun interpretation, implying that fine-tuning a model on visual data might impair its original linguistic capabilities. LM baseline models were not tested in this task against pun disambiguation as the task necessitates visual context.

### Socratic Models (SM)

SM (Zeng et al., 2022), also called pipelining (Bitton-Guetta et al., 2023), is a two-staged framework extending text-only LMs to multimodal tasks by first encoding the multimodal context to textual descriptions and inputting the same into the model. To implement SMs, the same language models are employed as previously mentioned, and BLIP-2 OPT2.7B (Li et al., 2023) is used as the visual description generator to encode visual information by generating textual captions from the images.

### Visual-Language Models (VLM)

Monolithic visual-language models directly take the raw images and user queries as inputs to produce textual responses. Two popular and high-performing VLMs are employed for this purpose: LLaVA 1.5 13B (Liu et al., 2023a) and Qwen-VLChat 7B (Bai et al., 2023). (Qwen-VLChat is displayed as Qwen-VL in result tables due to space constraints.)

For the tasks of pun disambiguation and pun reconstruction, a machine translation baseline model is also introduced. To this end, LLaVA is fine-tuned with the Multi30k multimodal machine translation dataset (Elliott et al., 2016), yielding the LLaVA-MMT version. For efficient implementation, the LoRA (Hu et al., 2021) method was used instead of full fine-tuning.

### 3.2. Do Images Help Pun Grounding?

### Evaluation Metrics

Accuracy is reported based on the equality of the model-estimated pun phrase and the ground-truth pun phrase. The equality is verified through the exact match of the text form, and the accuracy of the output is evaluated.

### Results

As anticipated, the incorporation of visual context led to a consistent improvement in pun grounding performance across all models, including Socratic Models and Visual-Language Models (see Table 4). In addition, GPT-4, a stronger model might solve the task even without visual context, verifying the original intention of proposing this task to test the helpfulness of visuals where the task is straightforward but the models are less capable.

TABLE 4
Results on the pun grounding task. We report the
exact match accuracy of the generated pun phrase.

| | Model | Inputs | Homo | | Hetero | |
|---|---|---|---|---|---|---|
| LM | Vicuna | L | 69.4 | | 71.2 | |
| | Qwen-VL | L | 43.8 | | 57.8 | |
| | LLaVA | L | 76.0 | | 71.8 | |
| | GPT-4 | L | 95.4 | | 92.0 | |
| SM | Vicuna | V + L | 74.6 | (↑5.2) | 76.6 | (↑5.4) |
| | GPT-4 | V + L | 96.0 | (↑0.6) | 92.4 | (↑0.4) |
| VLM | Qwen-VL | V + L | 63.6 | (↑19.8) | 70.8 | (↑13.0) |
| | LLaVA | V + L | 81.8 | (↑5.8) | 73.0 | (↑1.2) |
| | GPT-4 | V + L | 97.6 | (↑2.2) | 94.0 | (↑2.0) |

↑denotes the performance gain from visual context.

For evaluation fairness, a standard prompt template was employed across all models. While careful prompt engineering may further improve the scores, the findings focus on understanding the role of visual context in realistic scenarios rather than extracting the maximum potential from each model.

3.3. Can VLMs Disambiguate with Images?

### Evaluation Metrics

A generative evaluation is conducted for the pun disambiguation test. The task for the models is to translate a given pun sentence into a target language, using the accompanying image to disambiguate the meaning of the pun phrase. In this generative test, the text generated by the model is compared with two translation targets, and is considered an accurate result when it aligns more closely with the translation that corresponds to the context of the image. BERTScore (Zhang et al., 2019) was used to measure the text similarity.

### Results

All the baseline models have demonstrated their ability to disambiguate translation outputs based on visual context (see Table 5). Both strengthening the language model (Vicuna vs. GPT-4) and improving visual context processing (Vicuna with image captions from BLIP-2 vs. LLaVA) led to more accurate disambiguation.

TABLE 5
Experimental results on the pun disambiguation task. All scores
are reported in terms of binary classification accuracy.

| | | | En → De | | | En → Fr | | | En → Ko | | |
|---|---|---|---|---|---|---|---|---|---|---|---|
| | Model | Inputs | Homo | Hetero | All | Homo | Hetero | All | Homo | Hetero | All |
| | Random | | 50.0 | 50.0 | 50.0 | 50.0 | 50.0 | 50.0 | 50.0 | 50.0 | 50.0 |
| SM | Vicuna | V + L | 59.4 | 64.4 | 61.9 | 61.4 | 72.2 | 66.8 | 55.4 | 55.2 | 55.3 |
| | GPT-4 | V + L | 68.2 | 74.6 | 71.4 | 69.0 | 76.8 | 72.9 | 65.4 | 66.2 | 65.8 |
| VLM | Qwen-VL | V + L | 60.7 | 64.4 | 62.6 | 61.7 | 71.4 | 66.5 | 55.4 | 57.2 | 56.3 |
| | LLaVA | V + L | 65.1 | 70.8 | 68.0 | 61.1 | 70.6 | 65.8 | 58.1 | 56.9 | 57.5 |
| | LLaVA-MMT | V + L | 63.5 | 68.0 | 65.7 | 64.1 | 70.0 | 67.0 | 56.6 | 56.1 | 56.4 |

The best scores are bolded and the second-best ones are underlined.

Still, comprehending puns in the textual form was a more decisive factor for pun disambiguation than a visual understanding, as GPT-4 with image captions outperforms all other models. Interestingly, fine-tuning with the Multi30k multi-modal machine translation dataset (Elliott et al., 2016) harmed the accuracy of visual alignment. The fine-tuned model (LLaVA-MMT) underperforms the zero-shot LLaVA in nearly all aspects, except in the English-to-French translation of heterographic puns. This finding echoes previous research (Futeral et al., 2023), which suggests that multimodal machine translation datasets may not properly evaluate multimodal literacy capability.

### 3.4. Do Images Help Pun Reconstruction?

### Evaluation Metrics

The pun reconstruction task involves machines using both the human-translated text and the image context to reconstruct the original pun sentence. Then, the reconstructed pun sentence is compared with the original sentence for consistency in puns. Determining whether two sentences share the same pun is a complex task, and thus a machine-based evaluation method (GPTEval) with GPT4 (OpenAI, 2023) was introduced.

### Results

The results in Table 6 affirm that visual context significantly enhances machines' ability to reconstruct puns and manage their inherent ambiguity. For all models, the inclusion of images consistently improved the accuracy of pun reconstruction. The only exception was the weakest model in both language processing and visual comprehension (SM based on Vicuna).

TABLE 6
Outcomes for the pun reconstruction task, where ↑ and ↓ signify the performance change attributed to the inclusion of visual context.

| | | | | | | | | | | |
|---|---|---|---|---|---|---|---|---|---|---|
| | | Correct | Homo | | Correct | Hetero | | Correct | Hetero | |
| Model | Inputs | (%) | Bleu-4 | METEOR | (%) | Bleu-4 | METEOR | (%) | Bleu-4 | METEOR |

De→En

| LM | Vicuna | L | 27.9 | | 28.8 | 56.6 | 16.0 | | 29.1 | 65.1 | 22.0 | | 29.0 | 60.9 |
|---|---|---|---|---|---|---|---|---|---|---|---|---|---|---|
| | GPT-4 | L | 43.1 | | 30.8 | 66.1 | 45.2 | | 30.7 | 70.9 | 44.2 | | 30.4 | 68.5 |
| | Qwen-VL | L | 30.3 | | 29.4 | 58.8 | 20.3 | | 30.0 | 66.7 | 25.3 | | 29.7 | 62.8 |
| | LLaVA | L | 31.7 | | 27.7 | 57.9 | 19.0 | | 29.9 | 65.6 | 25.4 | | 28.8 | 61.8 |
| SM | Vicuna | V + L | 35.0 | (↑7.1) | 25.6 | 51.7 | 19.1 | (↑3.1) | 26.3 | 57.5 | 27.1 | (↑5.1) | 26.0 | 54.6 |
| | GPT-4 | V + L | 62.9 | (↑19.8) | 298 | 655 | 45.9 | (↑0.7) | 307 | 685 | 54.4 | (↑10.2) | 30.3 | 67.0 |
| VLM | Qwen-VL | V + L | 34.3 | (↑4.0) | 28.5 | 54.2 | 19.9 | (↑0.4) | 29.7 | 58.2. | 27.1 | (↑1.8) | 29.1 | 56.2 |
| | LLaVA | V + L | 33.2 | (↑1.5) | 28.7 | 55.1 | 20.1 | (↑1.1) | 29.2 | 61.2 | 26.7 | (↑1.3) | 26.0 | 58.2 |
| | GPT-4 | V + L | 65.2 | (↑22.1) | 29.9 | 63.8 | 50.6 | (↑5.4) | 29.3 | 65.3 | 57.9 | (↑13.7) | 29.6 | 64.6 |

| | | | | | | | | | | |
|---|---|---|---|---|---|---|---|---|---|---|
| LLaVA-MMT | V + L | 27.0 | 12.3 | 38.1 | 31.5 | 25.6 | 45.7 | 29.3 | 18.5 | 41.9 |

Fr→Em

| LM | Vicuna | L | 28.7 | | 28.0 | 57.6 | 19.2 | | 29.5 | 66.6 | 24.0 | | 28.8 | 62.1 |
|---|---|---|---|---|---|---|---|---|---|---|---|---|---|---|
| | GPT-4 | L | 60.0 | | 30.0 | 66.2 | 44.5 | | 30.1 | 70.3 | 52.3 | | 30.1 | 68.3 |
| | Qwen-VL | L | 31.5 | | 29.2 | 59.2 | 19.9 | | 30.4 | 67.7 | 25.7 | | 29.8 | 63.5 |
| | LLaVA | L | 32.6 | | 27.9 | 58.4 | 21.0 | | 29.3 | 67.7 | 26.8 | | 28.6 | 63.1 |
| SM | Vicuna | V + L | 38.4 | (↑9.7) | 24.0 | 50.5 | 18.1 | (↓1.1) | 25.3 | 55.9 | 28.3 | (↑4.3) | 24.7 | 53.2 |
| | GPT-4 | V + L | 63.6 | (↑3.6) | 29.2 | 65.1 | 45.2 | (↑0.7) | 30.7 | 68.1 | 54.4 | (↑2.1) | 30.0 | 66.6 |
| VLM | Qwen-VL | V + L | 37.0 | (↑5.5) | 28.1 | 55.7 | 22.4 | (↑2.5) | 29.6 | 61.7 | 29.7 | (↑4.0) | 28.9 | 58.7 |
| | LLaVA | V + L | 34.3 | (↑1.7) | 28.5 | 55.3 | 23.7 | (↑2.7) | 29.6 | 63.3 | 29 | (↑2.2) | 29.1 | 59.3 |
| | GPT-4 | V + L | 65.6 | (↑5.6) | 29.8 | 63.0 | 46.1 | (↑1.6) | 29.3 | 65.6 | 55.9 | (↑3.6) | 29.6 | 64.3 |

| | | | | | | | | | | |
|---|---|---|---|---|---|---|---|---|---|---|
| LLaVA-MMT | V + L | 33.3 | 12.9 | 39.3 | 27.0 | 24.3 | 43.2 | 30.2 | 17.8 | 41.3 |

Ko→En

| LM | Vicuna | L | 26.3 | | 25.4 | 48.3 | 11.1 | | 25.8 | 48.6 | 18.7 | | 25.6 | 48.5 |
|---|---|---|---|---|---|---|---|---|---|---|---|---|---|---|
| | GPT-4 | L | 62.7 | | 30.9 | 69.5 | 41.8 | | 29.5 | 65.5 | 52.3 | | 30.2 | 67.5 |
| | Qwen-VL | L | 26.6 | | 28.8 | 51.0 | 12.5 | | 28.1 | 51.7 | 19.6 | | 28.5 | 51.4 |
| | LLaVA | L | 27.9 | | 25.4 | 55.0 | 11.9 | | 25.5 | 50.6 | 19.9 | | 25.5 | 52.8 |
| SM | Vicuna | V + L | 31.9 | (↑5.6) | 20.3 | 38.7 | 16.6 | (↑5.5) | 20.3 | 35.4 | 24.3 | (↑5.6) | 20.3 | 37.1 |
| | GPT-4 | V + L | 68.1 | (↑5.4) | 30.7 | 69.9 | 46.4 | (↑4.6) | 29.3 | 64.4 | 57.3 | (↑5.0) | 30.0 | 67.2 |
| VLM | Qwen-VL | V + L | 35.5 | (↑8.9) | 26.8 | 46.2 | 18.3 | (↑5.8) | 26.7 | 45.9 | 26.9 | (↑7.3) | 26.8 | 46.1 |
| | LLaVA | V + L | 30.2 | (↑2.3) | 23.4 | 41.3 | 16.4 | (↑5.0) | 23.1 | 41.0 | 23.3 | (↑3.4) | 23.3 | 41.2 |
| | GPT-4 | V + L | 70.2 | (↑7.5) | 30.1 | 65.7 | 52.3 | (↑10.5) | 29.5 | 61.3 | 61.3 | (↑9.0) | 29.8 | 63.5 |

| | | | | | | | | | | |
|---|---|---|---|---|---|---|---|---|---|---|
| LLaVA-MMT | V + L | 28.0 | 6.3 | 38.5 | 18.3 | 15.0 | 46.7 | 23.3 | 10.7 | 42.6 |

The model with the largest performance increase is marked bold in each language.

Notably, unlike the main metric of correctness, the automatic text evaluation scores (Bleu-4 and METEOR) did not reflect a clear trend. Through manual inspection of the generated outputs, such scores were more aligned with changes in the surface form of the text, which did not correlate with the accurate identification of puns. This resonates with previous reports stating that such text scores are not fully effective outside of their original domain of machine translation (Liu et al., 2016).

Models found it more challenging to reconstruct heterographic puns than homographic ones. Incorporating visual context in these complex scenarios notably led to significant improvements in performance. Furthermore, the benefit of visual context became more evident when dealing with Korean inputs; a language considered divergent from English. This reinforces the idea that machines depend more on visual clues when tackling complex linguistic tasks. Finally, as in the pun disambiguation task, the fine-tuned LLaVA-MMT suffered from a decline in performance compared to the zero-shot LLaVA. This further supports the notion that visual understanding is essential to handle UNPIE.

UNPIE, a new benchmark, was introduced to evaluate the multimodal literacy capability. Based on UNPIE, three tests were crafted to measure how machines may utilize visual context to resolve inherent ambiguity in puns. The research results indicate that machines may leverage visual information to enhance their understanding of text, as shown by their improved performance across all tasks.

Although the above has been described with reference to preferred embodiments of the present disclosure, those skilled in the art will understand that various modifications and changes may be made without departing from the spirit and scope of the present disclosure as described in the claims below.
[National Research and Development Project Business Supporting the Present Disclosure]
[Project Serial Number] 2710006677

[Project Number] RS-2020-II201361
[Related Department] Ministry of Science and ICT
[Research Management Specialized Agency] Institute for Information & Communications Technology Planning & Evaluation (IITP)
[Research Project Business Title] Information, Communications, and Broadcasting Innovation Talent Nurturing Project (R&D)
[Research Project Title] Artificial Intelligence Graduate School Program (Yonsei University)
[Lead Institute] University Industry Foundation of Yonsei University
[Research Period] Jan. 1, 2024 to Dec. 31, 2024

### DETAILED DESCRIPTION OF MAIN ELEMENTS

100: device for resolving textual ambiguity through visual language inference model
110: pun identification unit
120: pun semantic interpretation unit
130: pun reconstruction unit

What is claimed is:

1. A device for resolving textual ambiguity through a visual language inference model, the device comprising:
a pun identification unit that input an image and an original text, identifies a pun phrase in the original text utilizing the image as a clue, and generates a plurality of candidate translations;
a pun semantic interpretation unit that input the plurality of candidate pun translations into the visual language inference model and decides a pun translation based on consistency with the image; and
a pun reconstruction unit that reconstructs the pun translation by reflecting an intention of the original text.

2. The device of claim 1, wherein the pun identification unit detects an important phrase in the original text by understanding correlation between visual information in the image and the original text.

3. The device of claim 2, wherein the pun identification unit decides multimodal context for the important phrase to compute pun possibility, and decides the important phrase as the pun phrase when the pun possibility is higher than a specific standard.

4. The device of claim 3, wherein the pun identification unit interprets the pun phrase according to the multimodal context to generate the plurality of candidate translations.

5. The device of claim 1, wherein the pun semantic interpretation unit input each of the plurality of candidate pun translations into the visual language inference model to detect a visual clue in the image.

6. The device of claim 5, wherein the pun semantic interpretation unit decides whether the image is able to be interpreted as a pun interpretation image reflecting the corresponding candidate pun translation through the detected visual clue.

7. The device of claim 6, wherein the pun semantic interpretation unit adopts the corresponding candidate pun translation as the pun translation when the image is interpreted as the pun interpretation image reflecting the corresponding candidate pun translation.

8. The device of claim 1, wherein the pun reconstruction unit infers the intention of the original text based on visual information of the image and rearranges the pun translation centered on delivery of a core keyword in the pun translation.

9. The device of claim 8, wherein the pun reconstruction unit input the rearranged pun translation into the visual language inference model to re-decide the consistency with the image.

10. A method for resolving textual ambiguity through a visual language inference model performed by a device for resolving the textual ambiguity, the method comprising:
a pun identification stage that input an image and an original text, identifies a pun phrase in the original text utilizing the image as a clue, and generates a plurality of candidate translations;
a pun semantic interpretation stage that input the plurality of candidate pun translations into the visual language inference model and decides a pun translation based on consistency with the image; and
a pun reconstruction stage that reconstructs the pun translation by reflecting an intention of the original text.
